(19) United States
(12) Patent Application Publication
(10) Pub. No.: US 2009/0228576 A1
(43) Pub. Date: Sep. 10, 2009

(54) SYSTEM AND METHOD FOR TESTING SOFTWARE

(76) Inventors: Avner Rosenan, Tel Aviv (IL); Ophir Kra-Oz, Tel Aviv (IL); Ronnie Maor, Moshav Mazor (IL); Leeor Aharon, Tel Aviv (IL)

Correspondence Address: Ostrow Kaufman & Frankl LLP;Susan Formicola, The Chrysler Building, 405 Lexington Avenue, 62nd Floor, NEW YORK, NY, 10174, US

(21) Appl. No.: 12/043,642

(22) Filed: Mar. 6, 2008

(51) Int. Cl. G06F 15/177; G06F 15/16

(52) U.S. Cl. 709/221; 709/227

(57) ABSTRACT

Embodiments of the present invention provide systems, methods and computer program products for testing software in a virtual private environment. One embodiment of a method for testing software in a virtual private environment includes cloning an original computing environment into one or more virtual environments, wherein the one or more virtual environments have identical configurations to the original computing environment and contain one or more client applications. The method further comprises determining a private network IP address corresponding to a registration request from an end user and establishing a connection between the end user and the virtual private network. The private network IP address is routed to a first of one or more identical virtual environments. Access is then allowed to the first virtual environment in order to allow the end user to test the one or more client applications on the first virtual environment.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to testing of software. More specifically, the present invention is directed towards systems and methods for testing of software in a virtual private environment.

### BACKGROUND OF THE INVENTION

Sales of computer software by development companies or third-party distributors to the consumer end user presents a variety of challenges to development and distribution companies. Specifically, development and distribution companies are faced with challenges relating to the number and quality of potential sales leads, the long sales cycle associated with multiple individuals involved in the purchase of software on behalf of a consumer end user, the rigorous evaluation process by the end user consumer and the limited control and visibility of the testing of the software product by the consumer end user.

Conventional sales techniques utilized by software development and distribution companies involved the distribution of demo and trial versions of their software products to potential consumer end users to be tested and evaluated by the consumer end users on separate networks or machines, without any involvement or participation by the software development and distribution companies. However, by utilizing this technique, software development and distribution companies cannot evaluate the quality of the potential sales leads nor determine the likelihood of a potential sales lead becoming a sale. Furthermore, utilizing this conventional method, software development and distribution companies are unable to receive feedback or supply customer service during the testing phase by the consumer end user. Additionally, with the use of separate networks or machines by the consumer end users, developers and distributors are unable to control the configuration of these separate networks or machines that would be necessary to properly execute the demo and trial versions of their software products.

Therefore, there exists a need for systems and methods for testing of software by the consumer end user that would allow software developers and distributors to receive feedback from the consumer end user, to supply customer service to the end user during the testing phase of software products and to ensure the proper configuration of the machines that will execute the demo and trial versions of their software products.

### SUMMARY OF THE INVENTION

Generally, the present invention provides for systems, methods and computer program products for testing software in a virtual private environment. The present invention is directed toward a method for testing software in a virtual private environment, the method comprising cloning an original computing environment into one or more virtual environments, wherein the one or more virtual environments have identical configurations to the original computing environment and contain one or more client applications. The method further comprises determining a private network IP address corresponding to a registration request from an end user and establishing a connection between the end user and the one or more virtual private environments. The private network IP address is routed to a first of one or more identical virtual environments. Access is then allowed to the first virtual environment in order to allow the end user to test the one or more client applications on the first virtual environment.

By allowing for the testing of software in a virtual private environment that is both centralized and monitored, software development and distribution companies can evaluate the quality of the potential sales leads and therefore, determine the likelihood of a potential sales lead becoming a sale. Furthermore, such a method allows for software development and distribution companies to receive feedback and supply customer service during the testing phase by the consumer end user, as well as ensure the proper configuration of the machines that will execute the demo and trial versions of their software products.

### BRIEF DESCRIPTION OF THE DRAWINGS

The invention is illustrated in the Figures of the accompanying drawings which are meant to be exemplary and not limiting, in which like references are intended to refer to like or corresponding parts, and in which:

FIG. 1 illustrates a block diagram of a system for testing software in a virtual private environment according to one embodiment of the present invention;

FIG. 2 illustrates a flow chart presenting a method for setting up virtual environments;

FIG. 3 illustrates a flow chart presenting a method for testing software in a virtual private environment according to one embodiment of the present invention;

FIG. 4 illustrates a detailed flow chart presenting a method for routing through a virtual private to allow access to a virtual environment containing the client application according to one embodiment of the present invention; and

FIGS. 5a through 5g illustrate flow diagrams for testing software within a system according to one embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

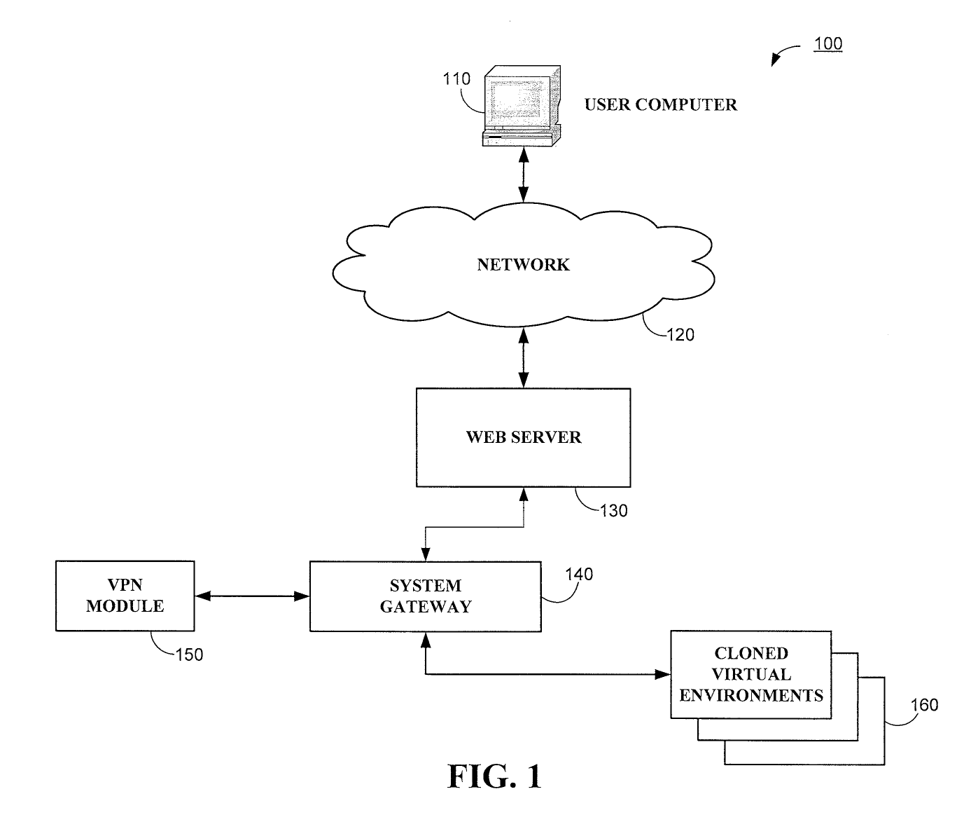

FIG. 1 illustrates one embodiment of a system for testing of software in a virtual private environment 100 that includes a user computer 110, a computer network 120, a web server 130, a System Gateway 140, a virtual private network module 150 and one or more clone virtual environments 160. The computer network 120 may be any type of computerized network capable of transferring data, such as the Internet. According to one embodiment of the invention, the user computer 110 is a general purpose personal computer comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc. The present invention is not limited to only the user computer 110 and may comprise additional, disparate computer devices. The user computer 110 is therefore presented for illustrative purposes representative of multiple computer devices.

According to one embodiment of the invention, the web server 130 is a programmable processor-based computer device that includes persistent and transient memory, as well as one or more network connection ports and associated hardware for transmitting and receiving data on the network 130. The web server 130 may host websites, store data, serve ads, etc. Those of skill in the art understand that any number and type of web server 130 and user computer 110 may be connected to the network 120.

According to one embodiment of the invention, the System Gateway 140 is a router or any other network device capable of serving as a node that serves as an entrance to another network in order to transfer data between networks, such as between a private network and the Internet. The VPN module 150 is a remote virtual private network system, as is well known in the art, which tunnels a secure dedicated communications network through another network. According to one embodiment, the VPN module 150 may comprise a dedicated server, a router and firewall in order to perform network address translations with proper authentication and security protocols in order to tunnel a virtual private network within the Internet.

According to one embodiment of the invention, the one or more clone virtual environments 160 may comprise physical machines, such as programmable processor-based computer devices that includes persistent and transient memory, as well as one or more network connection ports and associated hardware for transmitting and receiving data, and one or more client applications stored within the persistent memory and capable of operating on the computer device. According to another embodiment, the one or more clone virtual environments 160 may comprise virtual machines, which are self-contained operating environments that behave as if they were separate computer devices by utilizing the underlying hardware of the programmable processor-based computer devices upon which they are located. As is known in the art, and in general, a virtual machine utilizes the persistent and transient memory, as well as the one or more network connection ports and associated hardware for transmitting and receiving data, of the computer device upon which it is located. In addition, virtual machines utilize one or more client applications stored within the persistent memory, which are capable of operating within the operating system of the virtual computer.

According to one embodiment, the one or more clone virtual environments 160 are duplicates, comprising identical configurations, specifically identical hardware, software and network configurations, and being assigned identical IP addresses on the computer network 120. For example, every cloned virtual environment would comprise a physical or virtual computing device that has identical memory, processor, and hardware settings with an identical operating system, libraries, directories and client software applications; as well as with an identical network topology, assigned with the same IP address. The one or more clone virtual environments 160 are located on one or more virtual Local Area Networks (VLANs), where each VLAN has assigned to it a unique identification, known in the art as a VLAN ID. As each one of the one or more clone virtual environments 160 are located on separate VLANs, each one of the one or more clone virtual environments 160 are not in communication with each other, allowing identical network configurations to be maintained.

In accordance with one embodiment, the user computer 110 and the web server 130 are communicatively interconnected via the communications network 120. A virtual private network is tunneled by the VPN module 150 wherein the one or more clone virtual environments 160 located on the one or more VLANs are interconnected with the communication network 120 via the System Gateway 140.

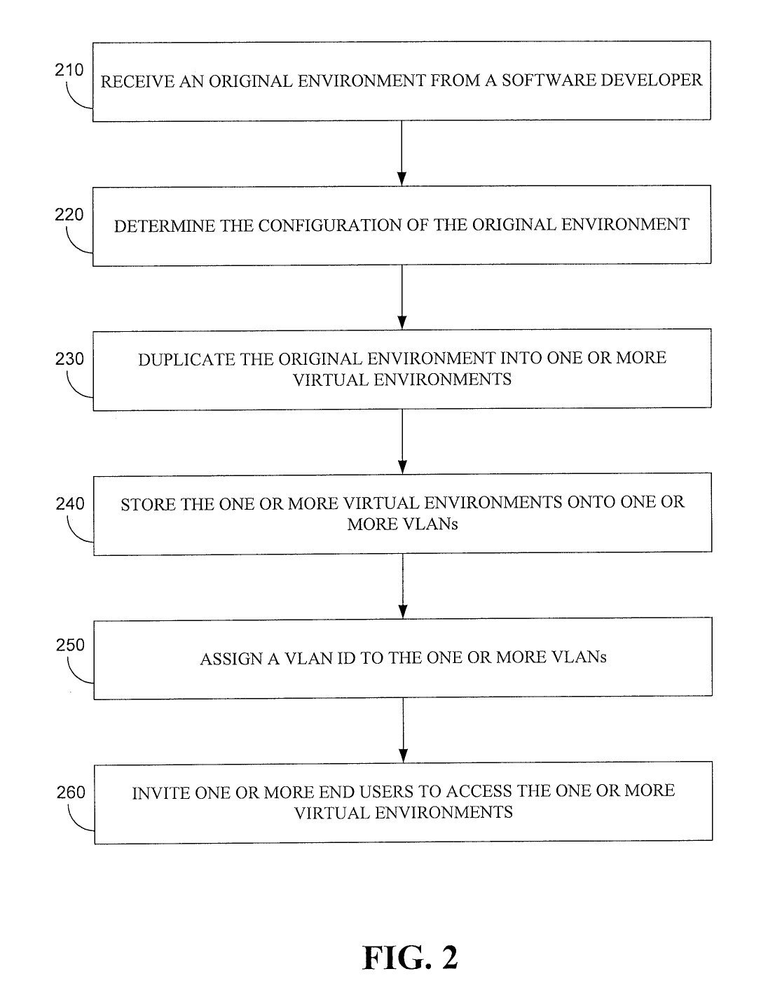

In accordance with one embodiment, the one or more clone virtual environments 160 are identical computing devices, which store and allow the operation of a client application developed by a software developer. The client application may be a software application that is in a development stage or is a final software application that may be purchased by consumer end users. In accordance with this feature, a consumer end user may be invited to a specific clone virtual environment or may be invited to any on of the one or more clone virtual environments 160. According to one embodiment, once a consumer end user is invited to a clone virtual environment, the consumer end user may access the clone virtual environment in order to test a software application and may be able to modify one or more of the computer hardware configurations, the computer software configurations or the computer network configurations of the clone virtual environment. Methods for testing software in a virtual private environment will be described in further detail below with respect to the description of FIGS. 2 through 5g.

In accordance with one embodiment, a consumer end user is invited by receiving registration information, such as a specific URL for an Internet website located at the web server 130 with a logon ID and password, from a software developer or distributor in order to gain access to and test the client application located on one of the one or more virtual environments 160. The web server 130 receives the registration information from the user computer 100 that is entered by the consumer end user. The web server 130 then forwards the registration request to the System Gateway 140 and then to the VPN module 150. The VPN module 150 tunnels a secured communication within the network 120 between the web server 130 and the user computer 110 and authenticates the registration information provided by the consumer end user. The VPN module 150 then forwards a private network IP address to the System Gateway 140. According to one embodiment, a private network IP address is an IP address that allows for the communication between the user computer 110 and the one or more cloned virtual environments 160 within the virtual private network established by the VPN module 150. For example, Check Point® Software Technologies LTD's VPN-1 SecuRemote and SecureClient technology assigns office-mode IP addresses in its virtual private network system, which are private network IP addresses encapsulated in the virtual private network and shielded from the public network in order to allow for a secured connection between a client and a host.

The System Gateway 140 contains a forwarding table that maps private network IP addresses of the virtual private network with an ID which corresponds to a VLAN ID upon which the virtual environment requested is located. Once the appropriate virtual environment on the VLAN is located, the consumer end user is able to access and test the software client application in the virtual private network established by the VPN module 150 within the computer network 120.

FIG. 2 illustrates a flow chart presenting a method for setting up virtual environments according to one embodiment of the present invention. In accordance with the embodiment of FIG. 2, the method comprises receiving an original environment from a software developer or distributor, step 210. The original environment would comprise a computing device that has memory, a processor, and certain hardware settings with an operating system, certain libraries and directories and one or more client software applications. According to one embodiment, the original environment would utilize the disk image of the physical computer device in order to operate one or more client applications. According to another embodiment, the original environment would utilize the virtual machine image of the virtual machine, which includes both the disk image and hardware properties of the physical machine utilized by the virtual machine to operate one or more client applications.

A determination is then made as to the configuration of the original environment, step 220. For example, a determination is made as to the hardware components and settings of the original environment, as well as the client software applications, operating system and libraries stored upon the hardware of the original environment, as well as the corresponding network settings. The original environment is then duplicated into one or more virtual environments, step 230. For example, an outside vendor would clone the original virtual environment, which may be a virtual machine, in order to create identical clone virtual machines, using virtualization technologies as is known in the art. Examples of virtualization technologies include NetApp® Flexcone™ or virtualization technologies offered by VMware®.

The end result are virtual environments, comprising identical configurations, specifically identical hardware, software and network configurations, and being assigned identical IP addresses on a computer network. As described in relation to FIG. 1, every cloned virtual environment would comprise a physical or virtual computing device that has identical memory, processor, and hardware settings with an identical operating system, libraries, directories and client software applications; as well as with an identical network topology, assigned with the same IP address.

The one or more virtual environments are then stored onto one or more VLANs, step 240. A unique VLAN ID is assigned to the one or more VLANs, Step 250. For example, each cloned virtual environment having the same IP address is located on separate VLANs having a unique VLAN ID. In this way, each cloned virtual environment can maintain identical hardware, software and network configurations, but can be distinguished using the VLAN ID.

One or more end users are then invited to access the one or more virtual environments, step 260. For example, a software developer or distributor invites a consumer end user to test the client application located within one of the one or more clone virtual environments. The invitation may be performed by the software developer or distributor directly or by an outside vendor using any of the conventional communication methods. In accordance with one embodiment, the client application may be customized specifically for a specific end user or may be a general client application suitable for any consumer end user. In accordance with this feature, a consumer end user may be invited to a specific virtual environment or may be invited to anyone of the one or more clone virtual environments.

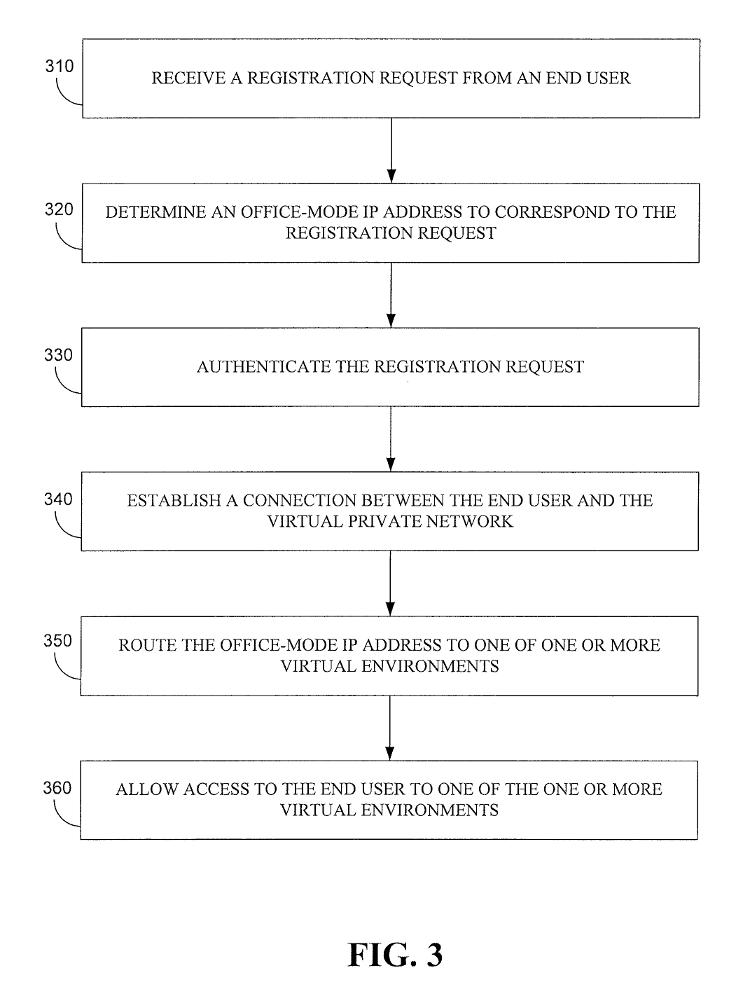

FIG. 3 illustrates a flow diagram presenting a method for testing software in a virtual private environment according to one embodiment of the present invention. In accordance with the embodiment of FIG. 3, the method comprises receiving a registration request from an end user, step 310, which may be accomplished at user interface, such as the display of a web page that may be located at a personal computer such as user computer 110 of FIG. 1. A private network IP address corresponding to the registration request is then determined, step 320, which may be accomplished at a web server of a virtual private network system, such as the web server 130 of the system 100.

The registration request is then authenticated, step 330. For example, the registration request, which includes a logon ID and a password, received at the user computer is transmitted to a server, such as the web server 130 of the system 100, and then to a VPN module, such as the VPN module 150, through a gateway. At the VPN module, the registration information is authenticated to ensure that the registration information is correct in order to ensure that the security of the virtual private network remains intact. In addition, the registration information can be used by the system to direct the consumer end user to the proper virtual environment. A connection is then established between the end user and the virtual private network, step 340. For example, the VPN module 150 of the system 100 tunnels a secured communication network between the end user computer and the cloned virtual environments.

The private network IP address corresponding to the registration request is then routed to one of the one or more virtual environments, step 350. Access to one of the one or more virtual environments is then allowed to the end user, step 360. Such access is made available via the tunneling of a virtual private network established by a virtual private network system, such as the VPN module 150 of the system 100, within a computer network, such as the Internet.

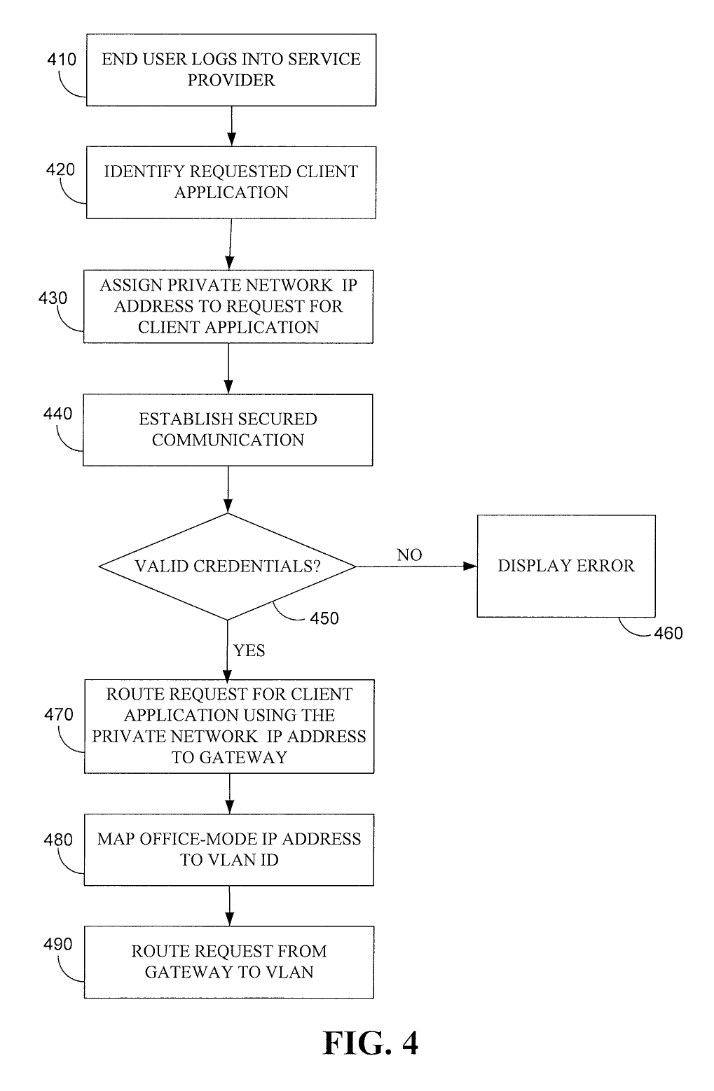

FIG. 4 illustrates a detailed flow diagram presenting a method for routing through a virtual private network to allow access to a virtual environment containing the client application according to one embodiment of the present invention. In accordance with the embodiment of FIG. 4, the method comprises the consumer end user logging into a service provider, step 410. For example, a consumer end user may log onto a web site maintained by a service provide on a web server, such as the web server 130 of the system 100, with a logon ID and password provided by the service provider to the end consumer. The requested client software application is then identified, step 420. For example, the credentials entered by the consumer end user is compared to a listing of software applications corresponding to specific users and their unique logon ID and password at a server, such as the web server 130 of the system 100.

At the server, the request for the software application also signals the assignment of a private network IP address to the request, step 430. The private network IP address corresponds to a specific virtual environment which stores and maintains the software application. The request for the application along with the corresponding private network IP address is then forwarded to a VPN module, such as the VPN module 150 of the system 100. The VPN module then establishes a secured connection, step 440, between the user computer and the virtual private network. At the VPN module, a determination is also made as to whether the credentials provided by the consumer end user are valid, step 450. If the credentials are not valid, the flow ends and the system displays an error to the consumer end user, step 460.

If the credentials are valid, the request for the client application with the corresponding private network IP address is then routed to a gateway, such as the System Gateway 140 of the system 100, step 470. At the gateway, the office mode IP address is mapped to a corresponding VLAN identification that corresponds to the VLAN upon which the virtual environment sought is located, step 480. The request for the client application is then routed from the gateway to the appropriate VLAN using the VLAN identification, step 490.

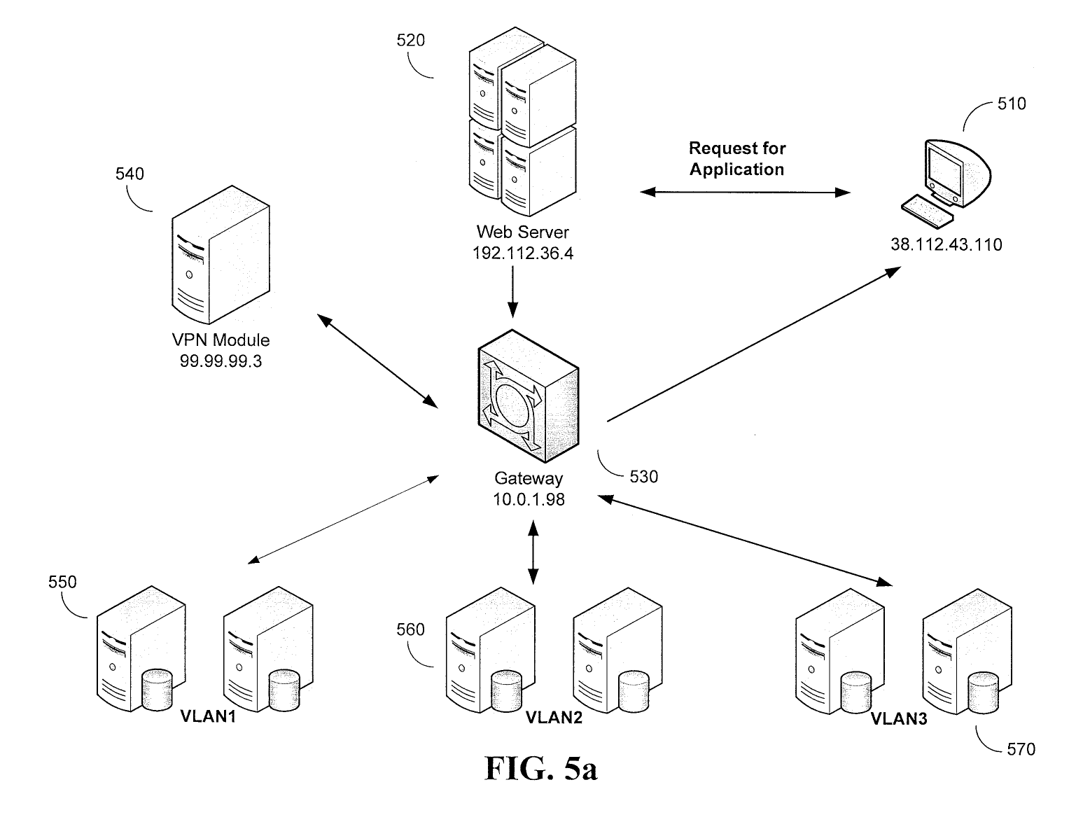

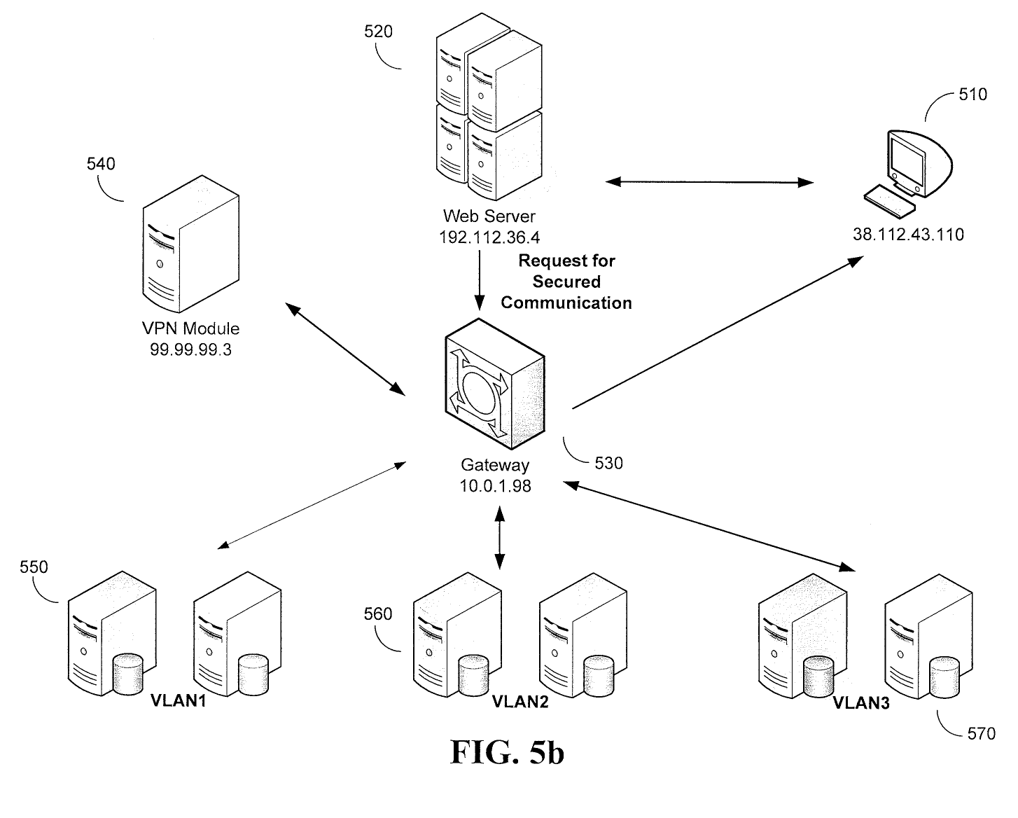

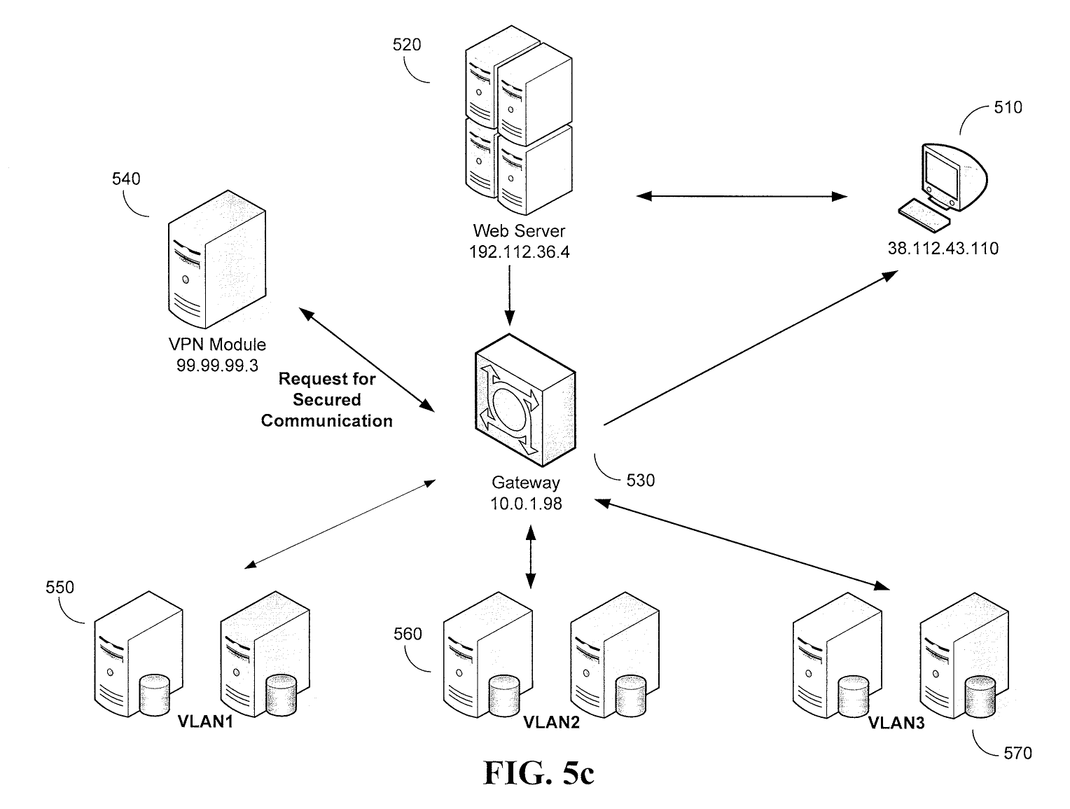

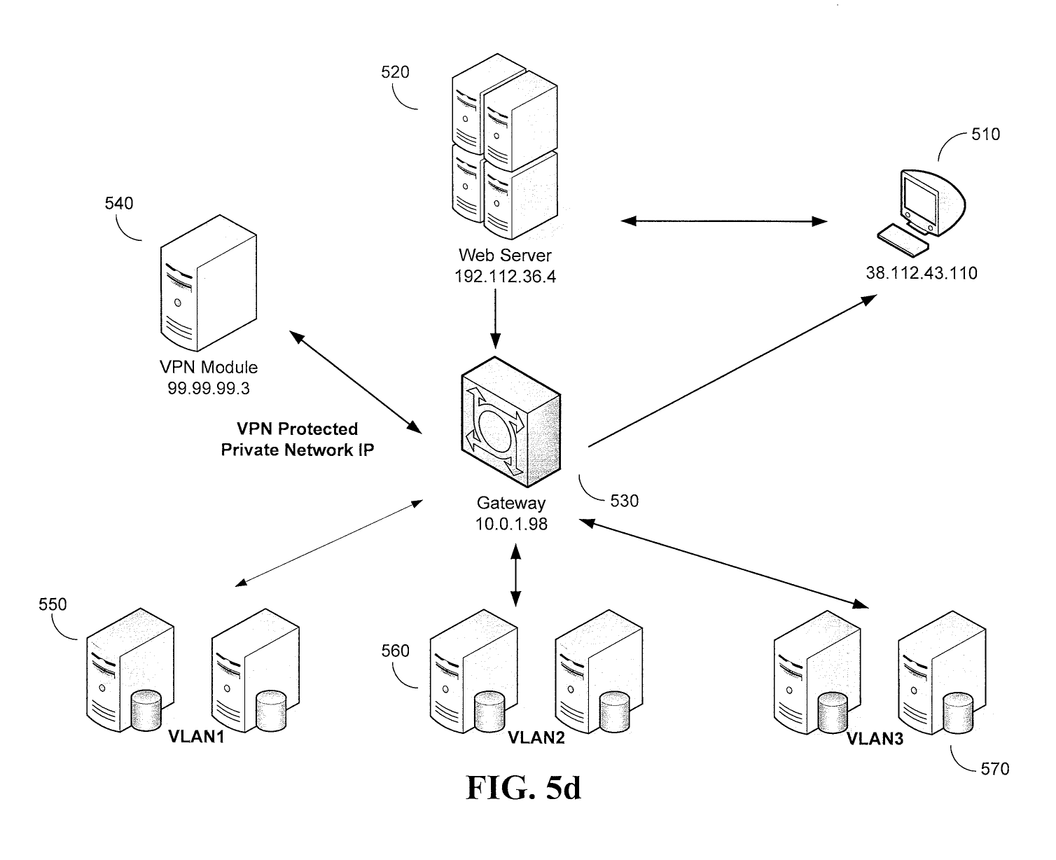

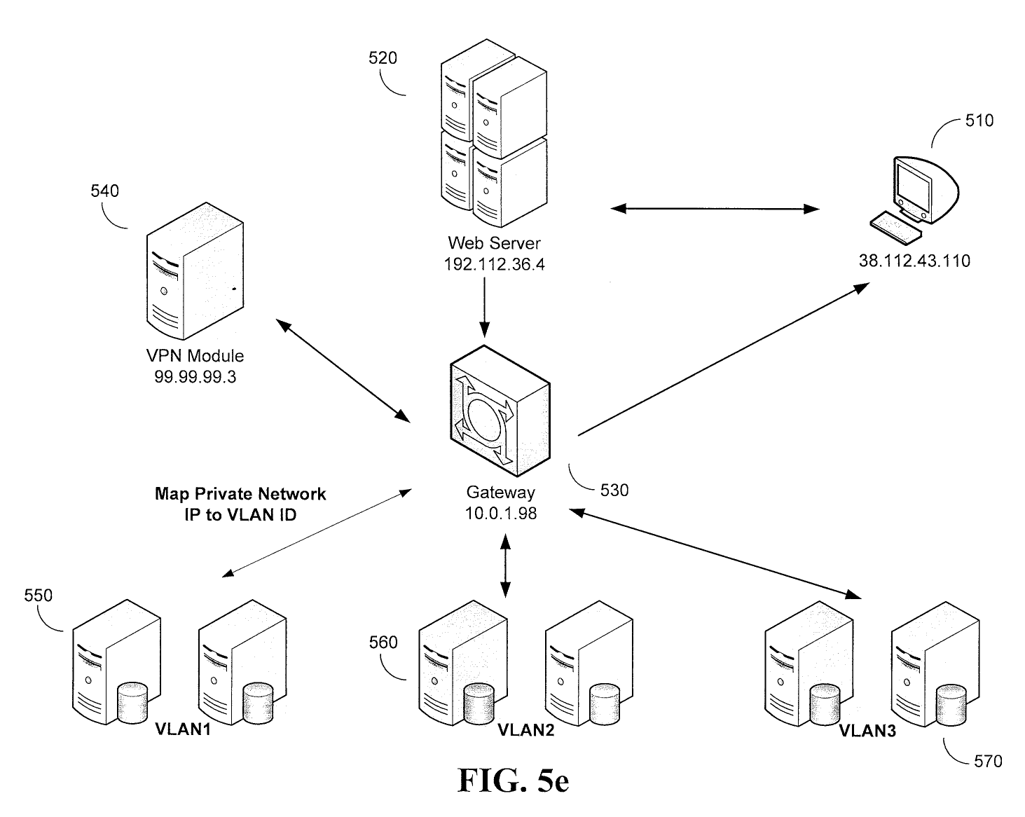

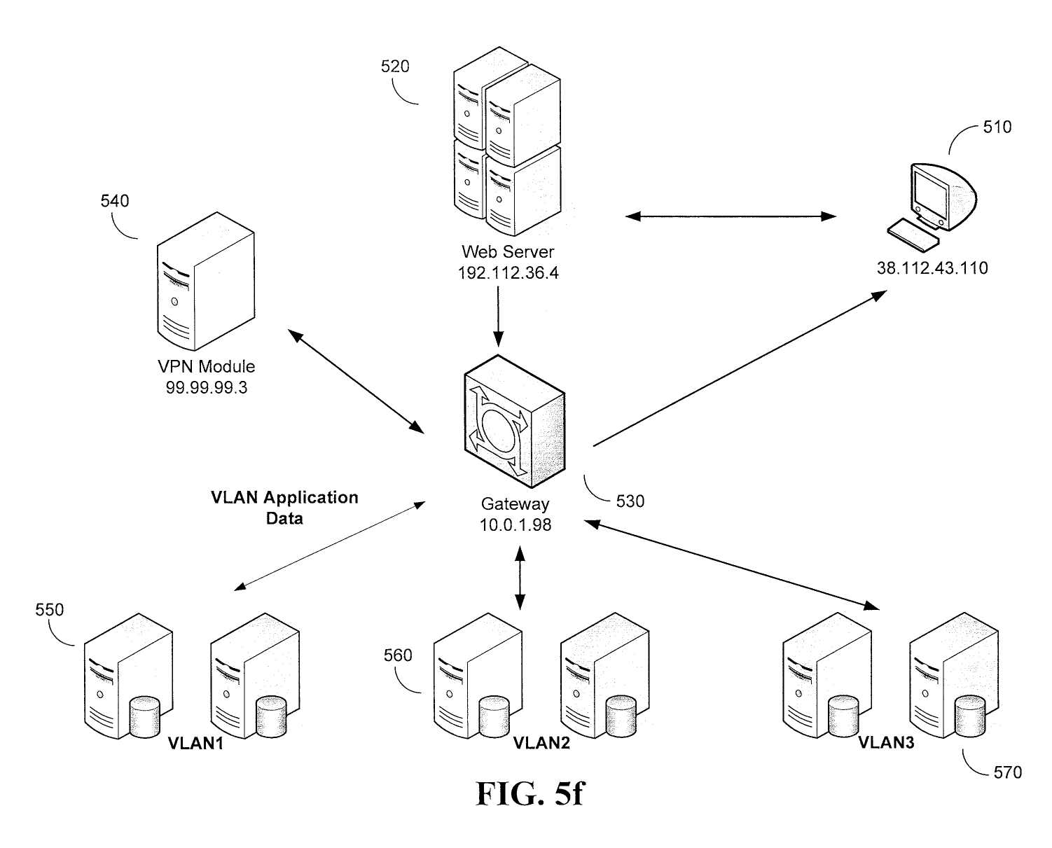

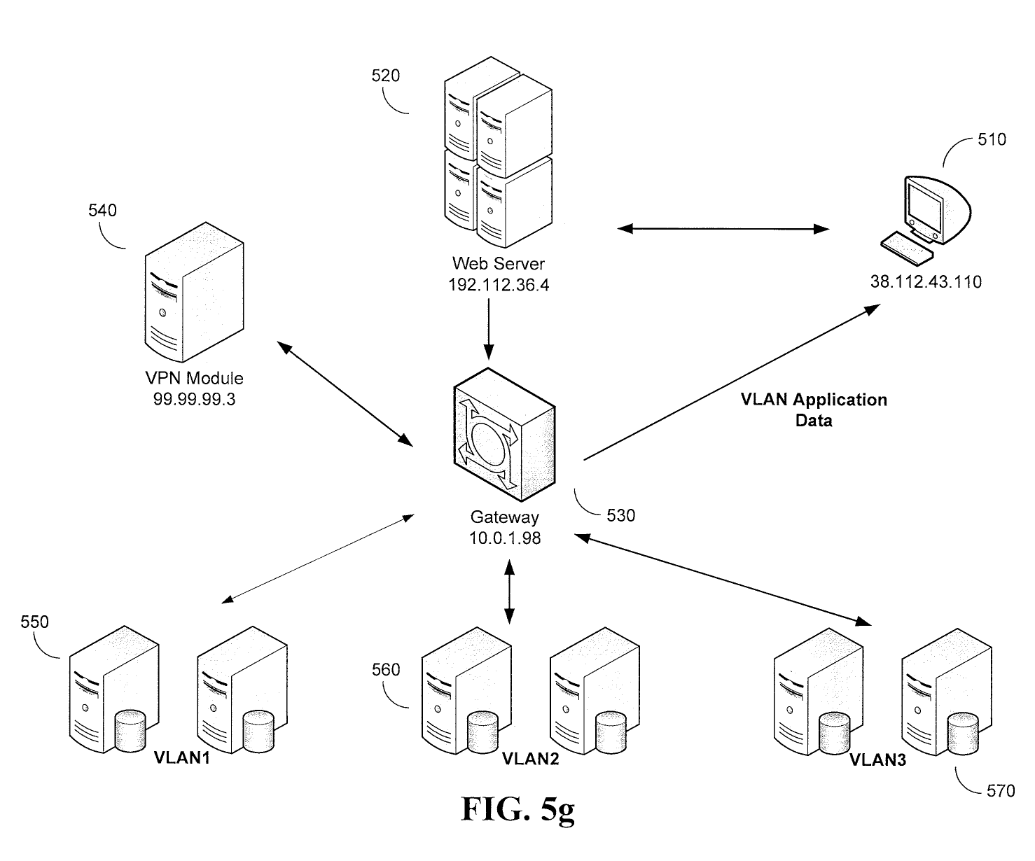

FIGS. 5a through 5g illustrate a detailed system diagram presenting a system for testing software in a virtual private environment according to one embodiment of the invention. In FIGS. 5a through 5g, a user computer 110 is located at the IP address 38.112.43.110, a web server 520 is located at the IP address 192.112.36.4, a gateway 530 is located at the IP address 10.0.1.98 and a VPN module 540 is located at the IP address 99.99.99.3. Clone virtual environments are located on separate VLANs, such as VLAN1 550, VLAN2 560 and VLAN3 570, where VLAN1, VLAN2 and VLAN3 are the respective VLAN identifications. In accordance with the embodiment of FIG. 5a, a request for a client software application is made by a consumer end user at the user computer 510 located at the IP Address 38.112.43.110 and forwarded to the web server 520 located the IP address 192.112.36.4. The request includes a logon and password, which identifies the specific consumer end user and the client application sought by the end user. Once a determination is made as to the client application that is sought, a private network IP address is assigned and a request for a secured connection is forwarded to the gateway 530 located at the IP address 10.0.1.98, as illustrated in FIG. 5b. The gateway 530 then forwards the request for the communication to the VPN module 540 located at the IP address 99.99.99.3, as illustrated in FIG. 5c. The VPN module 540 then tunnels a secured communication network and forwards the appropriate VPN protected private network IP address corresponding to the software client application sought, to the gateway 530, as illustrated in FIG. 5d.

The gateway 530 then maps the private network IP address to the corresponding VLAN identification for the VLAN upon which the virtual environment maintains the software client application sought. For example, as illustrated in FIG. 5e, the private network IP address 172.16.10.0/24 may correspond to the client software application sought which is located on VLAN1 350, which is why the private network IP address is mapped to the VLAN identification VLAN1. The client software application is then transmitted from the VLAN1 550 to the gateway 530, as illustrated in FIG. 5f. The client software application is then transmitted from the gateway 530 to the user computer 510, as illustrated in FIG. 5g.

Therefore, the present invention provides for systems, methods and computer program products for testing software in a virtual private network. By providing for such systems, methods and computer products in a centralized environment, software development and distribution companies can evaluate the quality of the potential sales leads and therefore, determine the likelihood of a potential sales lead becoming a sale, as well as receive feedback and supply customer service during the testing phase by the consumer end user. According to one embodiment of the invention, the system has the capability of allowing a software development or distribution company to monitor a consumer end user's testing of the software client application, as well as receive end user feedback and provide customer service during the testing of the software client application. Such functions can be accomplished by techniques well known in the art, such as summary reports of end user's testing, as well as e-mail messages or direct instant messaging techniques. Additionally, according to one embodiment, the system can set a predetermined time upon which a consumer end user can test the software application.

FIGS. 1 through 5g are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for testing of software in a virtual private environment, the method comprising:
cloning an original computing environment having a plurality of computer hardware configurations, a plurality of computer software configurations and a plurality of computer network configurations, into one or more virtual environments, wherein the one or more virtual environments have identical configurations to the original computing environment and contain one or more client applications;
determining a private network IP address corresponding to a registration request from an end user;
establishing a connection between the end user and the one or more virtual environments;
routing the private network IP address to a first of the one or more virtual environments, and
allowing access to the end user to the first virtual environment in order to allow the end user to test the one or more client applications on the first virtual environment.

2. The method of claim 1 further comprising, allowing the end user to modify one or more of the plurality of computer hardware configurations, the plurality of computer software configurations and the plurality of computer network configurations of the first virtual environment.

3. The method of claim 1, wherein cloning an original computing environment into one or more virtual environments, wherein the one or more virtual environments have identical configurations to the original computing environment and contain one or more client applications, comprises:
cloning the plurality of computer hardware configurations;
cloning the plurality of computer software configurations; and
cloning the plurality of computer network configurations.

4. The method of claim 1, wherein cloning an original computing environment into one or more virtual environments, wherein the one or more virtual environments have identical configurations to the original computing environment and contain one or more client applications, further comprises storing the one or more virtual environments on one or more virtual local area networks.

5. The method of claim 4, wherein storing the one or more virtual environments on one or more virtual local area networks, further comprises assigning a VLAN identification to the one or more virtual local area networks.

6. The method of claim 5, wherein routing the private network IP address to a first of the one or more virtual environments, comprises mapping the private network IP address to a corresponding VLAN identification assigned to the one or more virtual local area networks.

7. The method of claim 1, further comprising terminating access to the end user to the first virtual environment at the conclusion of a predetermined time period.

8. Computer readable media comprising program code that when executed by a programmable processor causes execution of a method for testing of software in a virtual private environment, the computer readable media comprising:
program code for cloning an original computing environment having a plurality of computer hardware configurations, a plurality of computer software configurations and a plurality of computer network configurations, into one or more virtual environments, wherein the one or more virtual environments have identical configurations to the original computing environment and contain one or more client applications;
program code for determining an private network IP address to correspond to a registration request from an end user;
program code for establishing a connection between the end user and the one or more virtual environments;
program code for routing the private network IP address to a first of the one or more virtual environments; and
program code for allowing access to the end user to the first virtual environment in order to allow the end user to test the one or more client applications on the first virtual environment.

9. The computer readable media of claim 8, further comprising program code for allowing the end user to modify one or more of the plurality of computer hardware configurations, the plurality of computer software configurations and the plurality of computer network configurations of the first virtual environment.

10. The computer readable media of claim 8, wherein program code for cloning an original computing environment into one or more virtual environments, wherein the one or more virtual environments have identical configurations to the original computing environment and contain one or more client applications, comprises:
program code for cloning the plurality of computer hardware configurations;
program code for cloning the plurality of computer software configurations; and
program code for cloning the plurality of computer network configurations.

11. The computer readable media of claim 8, wherein program code for cloning an original computing environment into one or more virtual environments, wherein the one or more virtual environments have identical configurations to the original computing environment and contain one or more client applications, further comprises program code for storing the one or more virtual environments on one or more virtual local area networks.

12. The computer readable media of claim 11, wherein program code for storing the one or more virtual environments on one or more virtual local area networks, further comprises program code for assigning a VLAN identification to the one or more virtual local area networks.

13. The computer readable media of claim 12, wherein program code for routing the private network IP address to a first of the one or more virtual environments, comprises program code for mapping the private network IP address to a corresponding VLAN identification assigned to the one or more virtual local area networks.

14. The computer readable media of claim 8, further comprising program code terminating access to the end user to the first virtual environment at the conclusion of a predetermined time period.

15. A system for testing of software in a virtual private environment, the system comprising:
one or more virtual environments, which have identical configurations to an original computing environment having a plurality of computer hardware configurations, a plurality of computer software configurations and a plurality of computer network configurations, and contain one or more client applications, operative to execute the one or more client applications;
a web server operative to determine a private network IP address corresponding to a registration request from an end user;
a virtual private network module operative to establish a connection between the end user and the one or more virtual environments;
a gateway operative to:
route the private network IP address to a first of one or more virtual environments; and
allow access to the end user to the first virtual environment in order to allow the end user to test the one or more client applications on the first virtual environment.

16. The system of claim 15, wherein the one or more virtual environments, further comprises:
identical computer hardware configurations;
identical computer software configurations; and
identical computer network configurations.

17. The system of claim 15, wherein the one or more virtual environments are operative to allow the end user to modify one or more of the plurality of computer hardware configurations, the plurality of computer software configurations and the plurality of computer network configurations of the first virtual environment.

18. The system of claim 15, further comprising one or more virtual local area networks wherein the one or more virtual environments are stored.

19. The system of claim 18, wherein the one or more virtual local area networks are assigned a VLAN identification.

20. The system of claim 19, wherein the gateway is operative to route the private network IP address to one of the one or more virtual environments by mapping the private network IP address to a corresponding VLAN identification assigned to the one or more virtual local area networks.

21. The system of claim 15, wherein the gateway is operative to terminate access to the end user to the first virtual environment at the conclusion of a predetermined time period.
